(19) United States
(12) Patent Application Publication
(10) Pub. No.: US 2026/0177785 A1
(43) Pub. Date: Jun. 25, 2026

(54) IMAGING OPTICAL LENS

(71) Applicant: Changzhou AAC Raytech Optronics Co., Ltd., Changzhou City (CN)

(72) Inventor: Tingting Yang, Changzhou (CN)

(21) Appl. No.: 19/340,858

(22) Filed: Sep. 25, 2025

Related U.S. Application Data
(63) Continuation of application No. PCT/CN2024/141497, filed on Dec. 23, 2024.

(51) Int. Cl. G02B 13/00; G02B 9/64

(52) U.S. Cl. CPC G02B 13/0045; G02B 9/64

(57) ABSTRACT

An imaging optical lens, including seven lenses, which are, from an object side to an image side, a first lens having a positive refractive power, a second lens having a negative refractive power, a third lens having a positive refractive power, a fourth lens having a negative refractive power, a fifth lens, a sixth lens having a positive refractive power and a seventh lens having a negative refractive power, which satisfy the following conditions: 1.10≤(R3+R4)/f≤1.70; 1.50≤f6/R12−f7/R14≤3.00; −3.30≤(R5+R6)/(R5−R6)≤−2.00; 3.00≤d1/d2≤12.00. The imaging optical lens of the present disclosure has excellent optical characteristics such as large-aperture, wide-angle and ultra-thinness design. The imaging optical lens has excellent optical characteristics, such as large-aperture, wide-angle and ultra-thinness characteristics.

### TECHNICAL FIELD

The present disclosure relates to the field of optical lenses and, in particular, to an imaging optical lens suitable for handheld terminal equipment such as smart phones, digital cameras, and camera devices such as monitors and PC lenses.

### BACKGROUND

In recent years, with the development of various smart devices, the demand for miniaturized imaging optical lenses has gradually increased. Since the pixel dimension of the photosensitive device is reduced, and the current electronic product has a development trend of high functionality and a slim and thin portable design. Therefore, miniaturized imaging optical lenses with good imaging quality have become the mainstream of the current market. In order to obtain better imaging quality, a multi-lenses structure is generally adopted. In addition, with the development of technology and the increase of diversified requirements of users, under the conditions that the pixel area of the photosensitive device continues to decrease and the requirement on the imaging quality of the system continues to increase, a seven-lenses structure has been gradually adopted in the lens design. There is an urgent need for a wide-angle camera lens having excellent optical characteristics with a small volume and fully corrected aberrations.

### SUMMARY

In view of the above problems, the main purpose of the present disclosure is to provide an imaging optical lens, which has good optical characteristic and meets design requirements of large-aperture, ultra-thinness and wide-angle design.

In order to achieve the above object, the technical solution of the present disclosure provides an imaging optical lens, including seven lenses, which are, from an object side to an image side, a first lens having a positive refractive power, a second lens having a negative refractive power, a third lens having a positive refractive power, a fourth lens having a negative refractive power, a fifth lens, a sixth lens having a positive refractive power and a seventh lens having a negative refractive power. An object-side surface of the first lens is convex in a paraxial region, an image-side surface of the first lens is concave in a paraxial region, an object-side surface of the second lens is convex in a paraxial region, an image-side surface of the second lens is concave in a paraxial region, an object-side surface of the third lens is convex in a paraxial region, an image-side surface of the third lens is concave in a paraxial region, an object-side surface of the fourth lens is concave in a paraxial region, an object-side surface of the fifth lens is convex in a paraxial region, an image-side surface of the fifth lens is concave in a paraxial region, an object-side surface of the sixth lens is convex in a paraxial region, an object-side surface of the seventh lens is convex in a paraxial region, and an image-side surface of the seventh lens is concave in a paraxial region; and a focal length of the imaging optical lens is f, a focal length of the sixth lens is f6, a focal length of the seventh lens is f7, a central curvature radius of the object-side surface of the second lens is R3, a central curvature radius of the image-side surface of the second lens is R4, a central curvature radius of the object-side surface of the third lens is R5, a central curvature radius of the image-side surface of the third lens is R6, a central curvature radius of an image-side surface of the sixth lens is R12, a central curvature radius of the image-side surface of the seventh lens is R14, an axial thickness of the first lens is d1, and an axial distance from the image-side surface of the first lens to the object-side surface of the second lens is d2, where

$$1.1 \leq ( R 3 + R 4 ) / f \leq 1.7 ;$$

$$1. 50 \leq f 6 / R 12 - f 7 / R 14 \leq 3. ; and$$

$$- 3.3 \leq ( R 5 + R 6 ) / ( R 5 - R 6 ) \leq - 2 \text{.00} ;$$

$$3. \leq d 1 / d 2 \leq 12.00 .$$

In an improvement, a total optical length of the imaging optical lens is TTL, a field of view of the imaging optical lens in a 1.0 field of view diagonal direction is FOV, and an image height at 1.0 field of view of the imaging optical lens is IH, where

$$0.01 \leq TTL / IH / FOV \leq 0.02 .$$

In an improvement, a focal length of the first lens is f1, where

$$0.95 \leq f 1 / f \leq 1.06 .$$

In an improvement, a central curvature radius of the object-side surface of the first lens is R1, a central curvature radius of an image-side surface of the first lens is R2, and a total optical length of the imaging optical lens is TTL, where

$$- 2.29 \leq ( R 1 + R 2 ) / ( R 1 - R 2 ) \leq - 1 \text{.75} ; and$$

$$0.123 \leq d 1 / TTL \leq 0.144 .$$

In an improvement, a focal length of the second lens is f2, an axial thickness of the second lens is d3, and a total optical length of the imaging optical lens is TTL, where

$$- 4.41 \leq f 2 / f \leq - 3.78 ;$$

$$6.97 \leq ( R 3 + R 4 ) / ( R 3 - R 4 ) \leq 9.18 ; and$$

$$0.017 \leq d 3 / TTL \leq 0.033 .$$

In an improvement, a focal length of the third lens is f3, an axial thickness of the third lens is d5, and a total optical length of the imaging optical lens is TTL, where

$$3. 00 \leq f 3 / f \leq 4.1 ; and$$

$$0.037 \leq d 5 / TTL \leq 0.059 .$$

In an improvement, a focal length of the fourth lens is f4, a central curvature radius of the object-side surface of the fourth lens is R7, a central curvature radius of the image-side surface of the fourth lens is R8, an axial thickness of the fourth lens is d7, and a total optical length of the imaging optical lens is TTL, where

$$- 6.90 \leq f 4 / f \leq - 3 \text{.53} ;$$

$$- 1.1 \; 7 \leq ( R 7 + R 8 ) / ( R 7 - R 8 ) \leq 0 \text{.94} ;$$

$$and$$

$$0. 023 \leq d 7 / TTL \leq 0.042 .$$

In an improvement, a focal length of the fifth lens is f5, a central curvature radius of the object-side surface of the fifth lens is R9, a central curvature radius of the image-side surface of the fifth lens is R10, an axial thickness of the fifth lens is d9, and a total optical length of the imaging optical lens is TTL, where

$$- 1 48.4 \leq f 5 / f \leq 45.43 ;$$

$$- 26. 63 \leq ( R 9 + R 10 ) / ( R 9 - R 10 ) \leq 47 \text{.79} ;$$

$$and$$

$$0.027 \leq d 9 / TTL \leq 0.063 .$$

In an improvement, a focal length of the sixth lens is f6, a central curvature radius of the object-side surface of the sixth lens is R11, an axial thickness of the fifth lens is d11, and a total optical length of the imaging optical lens is TTL, where

$$1.71 \leq f 6 / f \leq 2.92 ;$$

$$- 2. 3 \leq ( R 11 + R 12 ) / ( R 11 - R 12 ) \leq - 0 \text{.42} ;$$

$$and$$

$$0.084 \leq d 11 / TTL \leq 0.175 .$$

In an improvement, a focal length of the seventh lens is f7, a central curvature radius of the object-side surface of the seventh lens is R13, an axial thickness of the seventh lens is d13, and a total optical length of the imaging optical lens is TTL, where

$$- 1.08 \leq f 7 / f \leq - 0 \text{.78} ;$$

$$1.11 \leq ( R 13 + R 14 ) / ( R 13 - R 14 ) \leq 1.27 ;$$

$$and$$

$$0.082 \leq d 13 / TTL \leq 0.185 .$$

In an improvement, the first lens is made of glass.

### BRIEF DESCRIPTION OF DRAWINGS

In order to better illustrate the technical solutions in the embodiments of the present disclosure, the accompanying drawings required to be used in the description of the embodiments will be briefly described below. Obviously, the accompanying drawings in the following description are only some embodiments of the present disclosure, and for those skilled in the art, other accompanying drawings may also be obtained according to these accompanying drawings without any creative effort.

FIG. 1 is a schematic structural diagram of an imaging optical lens according to a first embodiment of the present disclosure;

FIG. 2 is a schematic diagram of axial chromatic aberration of the imaging optical lens shown in FIG. 1;

FIG. 3 is a schematic diagram of lateral chromatic aberration of the imaging optical lens shown in FIG. 1;

FIG. 4 is a schematic diagram of field curvature and distortion of the imaging optical lens shown in FIG. 1;

FIG. 5 is a schematic structural diagram of an imaging optical lens according to a second embodiment of the present disclosure;

FIG. 6 is a schematic diagram of axial chromatic aberration of the imaging optical lens shown in FIG. 5;

FIG. 7 is a schematic diagram of lateral chromatic aberration of the imaging optical lens shown in FIG. 5;

FIG. 8 is a schematic diagram of field curvature and distortion of the imaging optical lens shown in FIG. 5;

FIG. 9 is a schematic structural diagram of an imaging optical lens according to a third embodiment of the present disclosure;

FIG. 10 is a schematic diagram of axial chromatic aberration of the imaging optical lens shown in FIG. 9;

FIG. 11 is a schematic diagram of lateral chromatic aberration of the imaging optical lens shown in FIG. 9;

FIG. 12 is a schematic diagram of field curvature and distortion of the imaging optical lens shown in FIG. 9;

FIG. 13 is a schematic structural diagram of an imaging optical lens according to a fourth embodiment of the present disclosure;

FIG. 14 is a schematic diagram of axial chromatic aberration of the imaging optical lens shown in FIG. 13;

FIG. 15 is a schematic diagram of lateral chromatic aberration of the imaging optical lens shown in FIG. 13;

FIG. 16 is a schematic diagram of field curvature and distortion of the imaging optical lens shown in FIG. 13;

FIG. 17 is a schematic structural diagram of an imaging optical lens according to a fifth embodiment of the present disclosure;

FIG. 18 is a schematic diagram of axial chromatic aberration of the imaging optical lens shown in FIG. 17;

FIG. 19 is a schematic diagram of lateral chromatic aberration of the imaging optical lens shown in FIG. 17; and

FIG. 20 is a schematic diagram of field curvature and distortion of the imaging optical lens shown in FIG. 17.

### DESCRIPTION OF EMBODIMENTS

In order to better illustrate objectives, technical solutions, and advantages of embodiments of the present disclosure, the technical solutions in the embodiments of the present disclosure are described in details with reference to the accompanying drawings. It should be appreciated by those skilled in the art that in various embodiments of the present disclosure, numerous technical details are proposed for the reader to better understand the present disclosure. However, even without these technical details and various variations and modifications based on the following embodiments, the technical solutions claimed in the present disclosure can still be implemented.

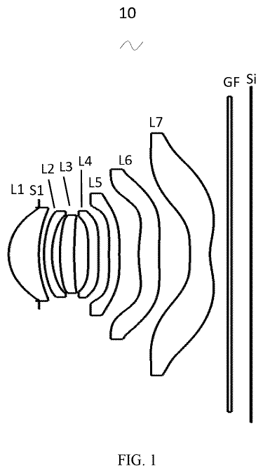

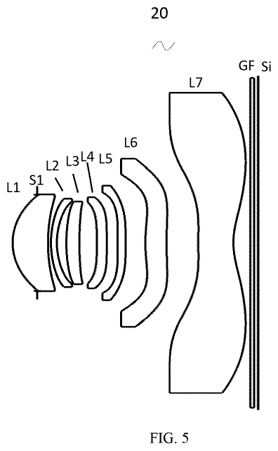

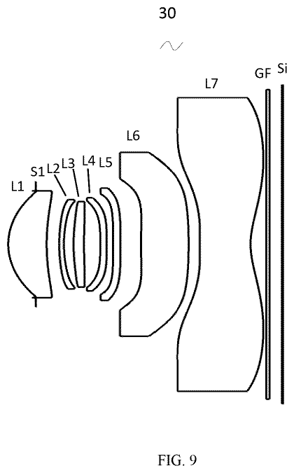

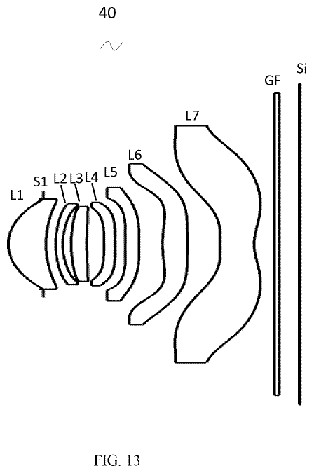

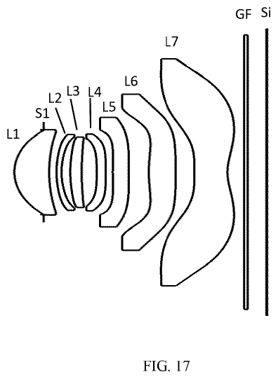

Referring to the drawings, the technical solution of the present disclosure provides imaging optical lenses 10, 20, 30, 40 and 50. FIG. 1, FIG. 5, FIG. 9, FIG. 13 and FIG. 17 show the imaging optical lenses 10, 20, 30, 40 and 50 according to the present disclosure. The imaging optical lenses 10, 20, 30, 40 and 50 each include seven lenses in total. In an embodiment, the imaging optical lens includes an aperture S1, a first lens L1, a second lens L2, a third lens L3, a fourth lens L4, a fifth lens L5, a sixth lens L6, and a seventh lens L7 sequentially from an object side to an image side. An optical element such as an optical filter GF may be provided between the seventh lens L7 and the image plane Si.

The first lens L1 is made of glass material, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. The lenses may also be made of other material.

A central curvature radius of an object-side surface of the second lens L2 is defined as R3, a central curvature radius of an image-side surface of the second lens L2 is defined as R4, and a focal length of the imaging optical lens is defined as f, then it is satisfied that: 1.10≤(R3+R4)/f≤1.70. Within this condition range, a surface shape of the second lens L2 is reasonably controlled, which is beneficial to reducing the sensitivity of the system, improving the manufacturing yield by reducing the molding difficulty, and meanwhile, the stray light generated by the lens can also be reduced, and the imaging quality of the lens can be improved.

A focal length of the sixth lens L6 is defined as f6, a focal length of the seventh lens L7 is defined as f7, a central curvature radius of an image-side surface of the sixth lens L6 is defined as R12, and a central curvature radius of an image-side surface of the seventh lens L7 is defined as R14, then it is satisfied that: 1.50≤f6/R12−f7/R14≤3.00. Within this condition range, the deflection degree in the edge field of view in the sixth lens L6 and the seventh lens L7 is effectively controlled, thereby reducing the sensitivity of the entire imaging optical lens.

A central curvature radius of an object-side surface of the third lens L3 is defined as R5, and a central curvature radius of an image-side surface of the third lens L3 is defined as R6, then it is satisfied that: −3.30≤(R5+R6)/(R5−R6)≤−2.00, specifying the shape of the third lens L3. Within this condition range, the field curvature offset of the central field of view is less than 0.03 mm.

An axial thickness of the first lens L1 is defined as d1, and an axial distance from an image-side surface of the first lens L1 to an object-side surface of the second lens L2 is defined as d2, then it is satisfied that: 3.00≤d1/d2≤12.00, specifying a ratio of the axial thickness of the first lens L1 to the axial distance from the image-side surface of the first lens L1 to the object-side surface of the second lens L2. Within this condition range, it facilitates decreasing the total length of the optical system.

When the above conditions are satisfied, the imaging optical lenses 10, 20, 30, 40, and 50 have good optical characteristic and can satisfy the requirements of large-aperture, wide-angle and ultra-thinness design. According to the characteristics of the imaging optical lenses 10, 20, 30, 40 and 50, the imaging optical lenses 10, 20, 30, 40 and 50 are particularly suitable for mobile phone camera lens assemblies consisting of camera elements such as CCD and CMOS for high pixels and WEB camera lenses.

Based on the above conditions and the implementable functions, the characteristics of each lens are further refined as follows.

A total optical length of the imaging optical lens is defined as TTL, a field of view of the imaging optical lens in a 1.0 field of view diagonal direction is FOV, and an image height of the imaging optical lens at a 1.0 field of view is IH, then it is satisfied that: 0.01≤TTL/IH/FOV≤0.02, specifying a ratio of the total optical length TTL of the imaging optical lens, the field of view FOV in the 1.0 field of view diagonal direction, and the image height IH at the 1.0 field of view.

A focal length of the first lens L1 is defined as f1, which satisfies the following relationship: 0.95≤f1/f≤1.06, specifying a ratio of the focal length f1 of the first lens L1 and the focal length f of the imaging optical lens. Within this condition range, the optical system has better imaging quality and lower sensitivity by reasonably allocating the optical focal length of the system.

An object-side surface of the first lens L1 is convex in a paraxial region, an image-side surface of the first lens L1 is concave in a paraxial region, and the first lens L1 has a positive refractive power. The object-side surface and the image-side surface of the first lens L1 may also be configured with other concave and convex arrangements.

A central curvature radius of an object-side surface of the first lens L1 is defined as R1, and a central curvature radius of an image-side surface of the first lens L1 is defined as R2, then it is satisfied that: −2.29≤(R1+R2)/(R1−R2)≤−1.75, and the shape of the first lens L1 is reasonably controlled, such that the first lens L1 can effectively correct the spherical aberration of the system.

An axial thickness of the first lens L1 is d1, and a total optical length of the imaging optical lens is TTL, then it is satisfied that: 0.123≤d1/TTL≤0.144. Within this condition range, it is beneficial to achieving ultra-thinness design.

An object-side surface of the second lens L2 is convex in a paraxial region, an image-side surface of the second lens L2 is concave in a paraxial region, and the second lens L2 has a negative refractive power. The object-side surface and the image-side surface of the second lens L2 may also be configured with other concave and convex arrangements.

A focal length of the second lens L2 is defined as f2, which satisfies: −4.41≤f2/f≤−3.78. Controlling the negative focal power of the second lens L2 within a reasonable range is beneficial to correct the aberration of the optical system.

A central curvature radius of an object-side surface of the second lens L2 is R3, and a central curvature radius of an image-side surface of the second lens L2 is R4, then it is satisfied that: 6.97≤(R3+R4)/(R3−R4)≤9.18, specifying the shape of the second lens L2. Within this condition range, it is beneficial to correcting the axial chromatic aberration with the development towards ultra-thinness and wide-angle design.

An axial thickness of the second lens L2 is d3, and a total optical length of the imaging optical lens is TTL, then it is satisfied that: 0.017≤d3/TTL≤0.033. Within this condition range, it is beneficial to achieving ultra-thinness design.

An object-side surface of the third lens L3 is convex in a paraxial region, an image-side surface of the third lens L3 is concave in a paraxial region, and the third lens L3 has a positive refractive power. The object-side surface and the image-side surface of the third lens L3 may also be configured with other concave and convex arrangements.

A focal length of the third lens L3 is defined as f3, which satisfies 3.00≤f3/f≤4.10. The optical system can achieve better imaging quality and lower sensitivity through reasonable distribution of the focal power.

An axial thickness of the third lens L3 is d5, and a total optical length of the imaging optical lens is TTL, then it is satisfied that: 0.037≤d5/TTL≤0.059. Within this condition range, it is beneficial to achieving ultra-thinness design.

An image-side surface of the fourth lens L4 is concave in a paraxial region, an object-side surface of the fourth lens L4 is concave or convex in a paraxial region. The fourth lens L4 has a negative refractive power. The object-side surface and the image-side surface of the fourth lens L4 may also be configured with other concave and convex arrangements.

A focal length of the fourth lens L4 is defined as f4, which satisfies: −6.90≤f4/f≤−3.53. The optical system can achieve better imaging quality and lower sensitivity through reasonable distribution of the focal power.

A central curvature radius of an object-side surface of the fourth lens L4 is R7, and a central curvature radius of an image-side surface of the fourth lens L4 is R8, then it is satisfied that: −1.17≤(R7+R8)/(R7−R8)≤0.94, specifying the shape of the fourth lens L4. Within the relevant range, it is beneficial to correcting aberration at off-axis field angles and other related issues with the development towards ultra-thinness and wide-angle design.

An axial thickness of the fourth lens L4 is d7, and a total optical length of an imaging optical lens is TTL, then it is satisfied that: 0.023≤d7/TTL≤0.042. Within this condition range, it is beneficial to achieving ultra-thinness design.

An object-side surface of the fifth lens L5 is convex in a paraxial position, and an image-side surface of the fifth lens L5 is concave in the paraxial position. The fifth lens L5 has a positive refractive power or a negative refractive power. The object-side surface and the image-side surface of the fifth lens L5 may also be configured other concave and convex arrangements.

A focal length of the fifth lens L5 is defined as f5, which satisfies:-148.40≤f5/f≤45.43. The optical system has better imaging quality and lower sensitivity through reasonable distribution of the refractive power.

A central curvature radius of an object-side surface of the fifth lens L5 is R9, and a central curvature radius of an image-side surface of the fifth lens L5 is R10, then it is satisfied that: −26.63≤(R9+R10)/(R9−R10)≤47.79, specifying the shape of the fifth lens L5. Within this condition range, it is beneficial to correcting aberration at off-axis field angles and the like with the development towards ultra-thinness and wide-angle design.

An on-axis thickness of the fifth lens L5 is d9, which satisfies the following relationship: 0.027≤d9/TTL≤0.063. Within the condition range, it is beneficial to achieving ultra-thinness design.

An object-side surface of the sixth lens L6 is convex in a paraxial region, an image-side surface of the sixth lens L6 is concave or convex in a paraxial region, and the sixth lens L6 has a positive refractive power. The object-side surface and the image-side surface of the sixth lens L6 may also be configured with other concave and convex arrangements.

A focal length of the sixth lens L6 is defined as f6, which satisfies the following relationship: 1.71≤f6/f≤2.92. The optical system has better imaging quality and lower sensitivity through reasonable distribution of the refractive powers.

A central curvature radius of an object-side surface of the sixth lens L6 is R11, and a central curvature radius of an image-side surface of the sixth lens L6 is R12, then it is satisfied that: −2.03≤(R11+R12)/≤−0.42, specifying the shape of the sixth lens L6. Within this condition range, it is beneficial to correcting aberration at off-axis filed angles and the like with the development towards ultra-thinness and wide-angle design.

An on-axis thickness of the sixth lens L6 is d11, which satisfies the following relationship: 0.084≤d11/TTL≤0.175. Within this condition range, it is beneficial to achieving ultra-thinness design.

An object-side surface of the seventh lens L7 is convex in a paraxial region, an image-side surface of the seventh lens L7 is concave in a paraxial region, and the seventh lens L7 has a negative refractive power. The object-side surface and the image-side surface of the seventh lens L7 may also be configured with other concave and convex arrangements.

A focal length of the seventh lens L7 is defined as f7, which satisfies the following relationship: −1.08≤f7/f≤−0.78. The optical system has better imaging quality and lower sensitivity through reasonable distribution of the refractive power.

A central curvature radius of an object-side surface of the seventh lens L7 is R13, and a central curvature radius of an image-side surface of the seventh lens L7 is R14, then it is satisfied that: 1.11≤(R13+R14)/≤1.27, specifying the shape of the seventh lens L7. Within the condition range, it is beneficial to correcting aberration at off-axis field angles and the like with the development towards ultra-thinness and wide-angle design.

An axial thickness of the seventh lens element L7 is d13, which satisfies the following relationship: 0.082≤d13/TTL≤0.185. Within this condition range, it is beneficial to achieving ultra-thinness design.

A field of view (FOV) of the imaging optical lens in a 1.0 field of view diagonal direction is greater than or equal to 74.98°. Within the condition range, it is beneficial to achieving the wide-angle design.

The f-number (FNO) of the imaging optical lens is less than or equal to 1.80. Within this condition range, it is beneficial to achieving a large aperture and achieving a good imaging performance of the imaging optical lens.

The imaging optical lens of the present disclosure will be described below with examples. The symbols recited in the examples are shown below. The units of the focal length, the axial distance, the central curvature radius and the axial thickness are all millimeter (mm).

Total optical length TTL: an axial distance from an object-side surface of a first lens L1 to an image plane Si, with a unit of mm.

F-number FNO: a ratio of an effective focal length of the imaging optical lens to an entrance pupil diameter.

Image height IH at 1.0 field of view: half of a diagonal length of an active pixel area of a sensor.

Field of view FOV in 1.0 field of view diagonal direction: a field of view corresponding to an active pixel area of a sensor.

Image high IH at MIC field of view: a height of the field of view expanding beyond the image height at 1.0 field of view for preventing assembly deviation.

Field of view FOVm in MIC-field of view diagonal direction: a field of view corresponding to an image height at MIC field of view.

In an example, the object-side surface and/or the image-side surface of the lens may also be provided with an inflection point and/or a standing point, to meet high-quality imaging requirements.

The technical solutions of the present disclosure are described in detail through the following five embodiments.

### First Embodiment

Table 1 and Table 2 show the design data of the imaging optical lens 10 according to the first embodiment of the present disclosure.

TABLE 1

| | R | d | | nd | | νd | |
|---|---|---|---|---|---|---|---|
| S1 | ∞ | d0= | −0.861 | | | | |
| R1 | 2.140 | d1= | 0.854 | nd1 | 1.4959 | ν1 | 81.65 |
| R2 | 5.580 | d2= | 0.146 | | | | |
| R3 | 4.607 | d3= | 0.225 | nd2 | 1.6797 | ν2 | 17.05 |
| R4 | 3.529 | d4= | 0.227 | | | | |
| R5 | 6.442 | d5= | 0.404 | nd3 | 1.5444 | ν3 | 55.82 |
| R6 | 13.898 | d6= | 0.397 | | | | |
| R7 | −631.003 | d7= | 0.287 | nd4 | 1.6700 | ν4 | 19.39 |
| R8 | 22.148 | d8= | 0.301 | | | | |
| R9 | 15.353 | d9= | 0.292 | nd5 | 1.6153 | ν5 | 25.94 |
| R10 | 17.932 | d10= | 0.559 | | | | |
| R11 | 5.090 | d11= | 0.581 | nd6 | 1.5661 | ν6 | 37.71 |
| R12 | 28.131 | d12= | 0.868 | | | | |
| R13 | 43.514 | d13= | 0.569 | nd7 | 1.5444 | ν7 | 55.82 |
| R14 | 2.601 | d14= | 0.500 | | | | |
| R15 | ∞ | d15= | 0.110 | ndg | 1.5168 | νg | 64.20 |
| R16 | ∞ | d16= | 0.540 | | | | |

The meanings of the various symbols are as follows.
S1: an aperture;
R: a curvature radius at a center of an optical surface;
R1: a central curvature radius of an object-side surface of a first lens L1;
R2: a central curvature radius of an image-side surface of a first lens L1;
R3: a central curvature radius of an object-side surface of a second lens L2;
R4: a central curvature radius of an image-side surface of a second lens L2;
R5: a central curvature radius of an object-side surface of a third lens L3;
R6: a central curvature radius of an image-side surface of a third lens L3;
R7: a central curvature radius of an object-side surface of a fourth lens L4;
R8: a central curvature radius of an image-side surface of a fourth lens L4;
R9: a central curvature radius of an object-side surface of a fifth lens L5;
R10: a central curvature radius of an image-side surface of a fifth lens L5;
R11: a central curvature radius of an object-side surface of a sixth lens L6;
R12: a central curvature radius of an image-side surface of a sixth lens L6;
R13: a central curvature radius of an object-side surface of a seventh lens L7;
R14: a central curvature radius of an image-side surface of a seventh lens L7;
R15: a central curvature radius of an object-side surface of an optical filter GF;
R16: a central curvature radius of an image-side surface of an optical filter GF;
d: an axial thickness of a lens, an axial distance between lenses;
d0: an axial distance from the aperture S1 to the object-side surface of the first lens L1;
d1: an axial thickness of the first lens L1;
d2: an axial distance from the image-side surface of the first lens L1 to the object-side surface of the second lens L2;
d3: an axial thickness of the second lens L2;
d4: an axial distance from the image-side surface of the second lens L2 to the object-side surface of the third lens L3;
d5: an axial thickness of the third lens L3;
d6: an axial distance from the image-side surface of the third lens L3 to the object-side surface of the fourth lens L4;
d7: an axial thickness of the fourth lens L4;
d8: an axial distance from the image-side surface of the fourth lens L4 to the object-side surface of the fifth lens L5;
d9: an axial thickness of the fifth lens L5;
d10: an axial distance from the image-side surface of the fifth lens L5 to the object-side surface of the sixth lens L6;
d11: an axial thickness of the sixth lens L6;
d12: an axial distance from the image-side surface of the sixth lens L6 to the object-side surface of the seventh lens L7;
d13: an axial thickness of the seventh lens L7;
d14: an axial distance from the image-side surface of the seventh lens L7 to the object-side surface of the optical filter GF;
d15: an axial thickness of the optical filter GF;
d16: an axial distance from the image-side surface of the optical filter GF to an image plane Si;
nd: a refractive index of d line (d line represents green light with a wavelength of 550 nm);
nd1: a refractive index of d line of the first lens L1;
nd2: a refractive index of d line of the second lens L2;
nd3: a refractive index of d line of the third lens L3;
nd4: a refractive index of d line of the fourth lens L4;
nd5: a refractive index of d line of the fifth lens L5;
nd6: a refractive index of d line of the sixth lens L6;
nd7: a refractive index of d line of the seventh lens L7;
ndg: refractive index of d line of the optical filter GF;
vd: an Abbe number;
v1: an Abbe number of the first lens L1;
v2: an Abbe number of the second lens L2;
v3: an Abbe number of the third lens L3;
v4: an Abbe number of the fourth lens L4;
v5: an Abbe number of the fifth lens L5;
v6: an Abbe number of the sixth lens L6;
v7: an Abbe number of the seventh lens L7; and
vg: an Abbe number of the optical filter GF.

Table 2 and Table 3 show the aspherical surface data of the lenses in the imaging optical lens 10 according to the first embodiment of the present disclosure.

TABLE 2

| | Conical Coefficient | Aspherical Coefficient | | | | | |
|---|---|---|---|---|---|---|---|
| | k | A4 | A6 | A8 | A10 | A12 | A14 |
| R1 | −4.9087E−01 | 5.8518E−03 | 2.2636E−03 | −8.8966E−03 | 3.3874E−02 | −7.5167E−02 | 1.0661E−01 |
| R2 | 6.2694E−01 | −3.2781E−03 | 1.0324E−02 | −3.7081E−02 | 1.0486E−01 | −2.0286E−01 | 2.6729E−01 |
| R3 | 3.8208E+00 | −1.6437E−02 | −1.7843E−02 | 1.3904E−01 | −4.8569E−01 | 1.1197E+00 | −1.8033E+00 |
| R4 | 1.7110E+00 | −1.8733E−02 | 1.7752E−02 | −5.7271E−02 | 1.6130E−01 | −2.2166E−01 | −3.3716E−02 |
| R5 | 1.6813E+01 | −9.6632E−03 | −7.7586E−02 | 5.9791E−01 | −2.8213E+00 | 8.6471E+00 | −1.8074E+01 |
| R6 | 8.5144E+01 | −1.8663E−02 | 5.8550E−02 | −4.0534E−01 | 1.7080E+00 | −4.7662E+00 | 9.2110E+00 |
| R7 | 5.9278E+01 | −4.5968E−02 | −6.1295E−02 | 3.7193E−01 | −1.3700E+00 | 3.2811E+00 | −5.4969E+00 |
| R8 | −9.9907E+01 | −5.7213E−02 | 2.8630E−02 | −5.8291E−02 | 1.7150E−01 | −4.9203E−01 | 9.3312E−01 |
| R9 | 5.8719E+01 | −1.0059E−01 | 1.4365E−01 | −4.1594E−01 | 1.1424E+00 | −2.2515E+00 | 3.0971E+00 |
| R10 | 5.6517E+01 | −1.0485E−01 | 7.6049E−02 | −7.8573E−02 | 1.0600E−01 | −1.2990E−01 | 1.2104E−01 |
| R11 | −2.9995E+01 | −1.3814E−02 | −7.3438E−03 | −4.8427E−03 | 1.0430E−02 | −9.9212E−03 | 5.9983E−03 |
| R12 | −8.2574E+01 | −1.1081E−02 | −7.4525E−04 | −2.1534E−03 | 1.4614E−03 | −8.9933E−04 | 5.9323E−04 |
| R13 | 8.2660E+01 | −1.4079E−01 | 7.1192E−02 | −3.0911E−02 | 1.0621E−02 | −2.6027E−03 | 4.5227E−04 |
| R14 | −1.2165E+01 | −6.9435E−02 | 2.9755E−02 | −1.0266E−02 | 2.5769E−03 | −4.4852E−04 | 5.2079E−05 |

TABLE 3

| | Aspherical Coefficient | | | | | | | |
|---|---|---|---|---|---|---|---|---|
| | A16 | A18 | A20 | A22 | A24 | A26 | A28 | A30 |
| R1 | −1.0108E−01 | 6.5480E−02 | −2.9078E−02 | 8.7045E−03 | −1.6785E−03 | 1.8820E−04 | −9.3207E−06 | 0.0000E+00 |
| R2 | −2.4388E−01 | 1.5584E−01 | −6.9624E−02 | 2.1329E−02 | −4.2743E−03 | 5.0516E−04 | −2.6715E−05 | 0.0000E+00 |
| R3 | 2.0847E+00 | −1.7491E+00 | 1.0652E+00 | −4.6559E−01 | 1.4224E−01 | −2.8821E−02 | 3.4792E−03 | −1.8937E−04 |
| R4 | 6.9899E−01 | −1.3422E+00 | 1.4230E+00 | −9.6306E−01 | 4.2675E−01 | −1.2031E−01 | 1.9633E−02 | −1.4144E−03 |
| R5 | 2.6551E+01 | −2.7866E+01 | 2.0988E+01 | −1.1252E+01 | 4.1906E+00 | −1.0302E+00 | 1.5030E−01 | −9.8561E−03 |
| R6 | −1.2679E+01 | 1.2630E+01 | −9.1422E+00 | 4.7707E+00 | −1.7521E+00 | 4.3070E−01 | −6.3773E−02 | 4.3127E−03 |
| R7 | 6.6264E+00 | −5.7943E+00 | 3.6509E+00 | −1.6213E+00 | 4.8542E−01 | −8.9951E−02 | 8.5558E−03 | −2.2788E−04 |
| R8 | −1.1639E+00 | 9.8076E−01 | −5.6368E−01 | 2.1834E−01 | −5.4713E−02 | 8.0757E−03 | −5.5295E−04 | 4.5729E−06 |
| R9 | −3.0225E+00 | 2.1169E+00 | −1.0658E+00 | 3.8177E−01 | −9.4775E−02 | 1.5469E−02 | −1.4903E−03 | 6.4090E−05 |
| R10 | −8.2259E−02 | 4.0268E−02 | −1.4047E−02 | 3.4365E−03 | −5.7355E−04 | 6.2024E−05 | −3.9103E−06 | 1.0900E−07 |
| R11 | −2.4430E−03 | 6.8077E−04 | −1.3023E−04 | 1.7017E−05 | −1.4900E−06 | 8.3518E−08 | −2.7067E−09 | 3.8542E−11 |
| R12 | −2.8082E−04 | 8.7072E−05 | −1.7949E−05 | 2.4909E−06 | −2.3059E−07 | 1.3671E−08 | −4.6988E−10 | 7.1219E−12 |
| R13 | −5.6708E−05 | 5.1982E−06 | −3.4926E−07 | 1.7029E−08 | −5.8680E−10 | 1.3549E−11 | −1.8809E−13 | 1.1864E−15 |
| R14 | −3.6582E−06 | 8.7725E−08 | 1.0225E−08 | −1.2666E−09 | 6.9411E−11 | −2.1767E−12 | 3.7813E−14 | −2.8362E−16 |

For convenience, the aspherical surfaces of the lens surfaces are defined as the aspherical surface indicated by the following Equation (1). However, the present disclosure is not limited to the aspherical polynomial form indicated by formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

In Equation (1), k represents a conical coefficient, A4, A6, A8, A10, A12, A14, A16, A18, A20, A22, A24, A26, A28 and A30 represent aspherical coefficients, c represents a curvature at a center of an optical surface, r represents a perpendicular distance from a point on a curved line of the aspherical surface to an optical axis, and z represents a depth of the aspherical surface (a perpendicular distance from a point, at a perpendicular distance r from the optical axis, on the aspherical surface to a tangent plane tangent to a vertex of the aspherical surface on the optical axis).

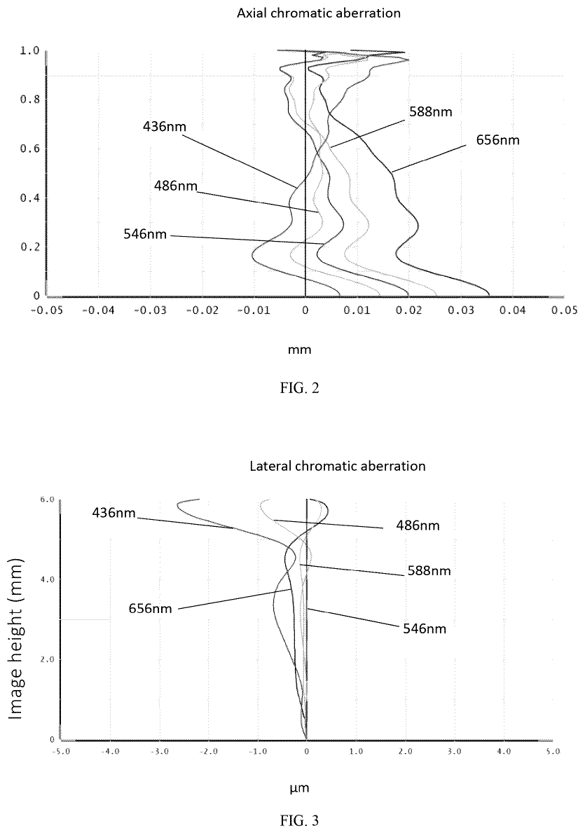

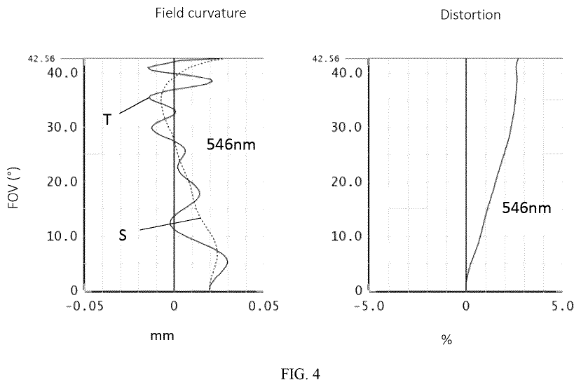

FIG. 2 and FIG. 3 respectively show axial chromatic aberration and lateral chromatic aberration of the light at wavelengths of 656 nm, 588 nm, 546 nm, 486 nm and 436 nm after passing through the imaging optical lens 10 according to the first embodiment. FIG. 4 shows field curvature and distortion of light at a wavelength of 546 nm after passing through the imaging optical lens 10 according to the first embodiment. In FIG. 4, S denotes a field curvature in a sagittal direction, and T denotes a field curvature in a meridional direction.

In an example, a pupil entering diameter ENPD of the imaging optical lens 10 is 3.523 mm, the image height IH at 1.0 field of view is 6.000 mm, and the field of view FOV in the 1.0 field of view diagonal direction is 85.11°, the image height IHm at MIC field of view is 6.300 mm, and the field of view FOVm in the MIC field of view diagonal direction is 87.71°. The imaging optical lens 10 meets the requirements of large-aperture, wide-angle and ultra-thinness design, the axial and off-axis chromatic aberrations are fully corrected, and it has excellent optical characteristics.

### Second Embodiment

The second embodiment is substantially the same as the first embodiment. The reference signs of the second embodiment have the same meaning as the first embodiment, and only the differences are listed below.

In an example, the fifth lens L5 has a negative refractive power.

Table 4 shows the design data of the imaging optical lens 20 according to the second embodiment of the present disclosure.

TABLE 4

| | R | d | | nd | | νd | |
|---|---|---|---|---|---|---|---|
| S1 | ∞ | d0= | −0.720 | | | | |
| R1 | 2.320 | d1= | 1.042 | nd1 | 1.4959 | ν1 | 81.65 |
| R2 | 6.999 | d2= | 0.087 | | | | |
| R3 | 3.791 | d3= | 0.173 | nd2 | 1.6797 | ν2 | 17.05 |
| R4 | 3.046 | d4= | 0.278 | | | | |
| R5 | 6.609 | d5= | 0.386 | nd3 | 1.5444 | ν3 | 55.82 |
| R6 | 13.792 | d6= | 0.513 | | | | |
| R7 | −33.268 | d7= | 0.291 | nd4 | 1.6700 | ν4 | 19.39 |
| R8 | 200.490 | d8= | 0.324 | | | | |
| R9 | 21.805 | d9= | 0.227 | nd5 | 1.6153 | ν5 | 25.94 |
| R10 | 20.911 | d10= | 0.586 | | | | |
| R11 | 5.999 | d11= | 0.624 | nd6 | 1.5661 | ν6 | 37.71 |
| R12 | 17.726 | d12= | 0.944 | | | | |
| R13 | 27.488 | d13= | 1.030 | nd7 | 1.5444 | ν7 | 55.82 |
| R14 | 3.171 | d14= | 0.500 | | | | |
| R15 | ∞ | d15= | 0.110 | ndg | 1.5168 | νg | 64.20 |
| R16 | ∞ | d16= | 0.128 | | | | |

Table 5 and Table 6 show the aspherical surface data of the lenses in the imaging optical lens 20 according to the second embodiment of the present disclosure.

TABLE 5

| | Conical Coefficient | Aspherical Coefficient | | | | | |
|---|---|---|---|---|---|---|---|
| | k | A4 | A6 | A8 | A10 | A12 | A14 |
| R1 | −5.3050E−01 | 4.3131E−03 | 6.5999E−03 | −1.9330E−02 | 4.0260E−02 | −5.7102E−02 | 5.7297E−02 |
| R2 | 1.2334E+00 | −6.6905E−03 | 1.4699E−02 | −5.2104E−03 | −3.3847E−02 | 9.5757E−02 | −1.4170E−01 |
| R3 | 2.8384E+00 | −3.1817E−02 | 2.9794E−02 | −3.8981E−02 | 8.7651E−02 | −2.0490E−01 | 3.5708E−01 |
| R4 | 1.4198E+00 | −2.5051E−02 | −1.0011E−03 | 1.3645E−01 | −6.3625E−01 | 1.8546E+00 | −3.7338E+00 |
| R5 | 1.6988E+01 | −7.7310E−03 | −1.8004E−02 | 1.4209E−01 | −6.1509E−01 | 1.7441E+00 | −3.4409E+00 |
| R6 | 8.3451E+01 | −7.5792E−03 | 1.4309E−02 | −1.0479E−01 | 4.4380E−01 | −1.1959E+00 | 2.1945E+00 |
| R7 | 5.9278E+01 | −4.6424E−02 | 7.4427E−02 | −3.8607E−01 | 1.2872E+00 | −3.0268E+00 | 5.1048E+00 |
| R8 | 9.9900E+01 | −4.8464E−02 | 4.8457E−02 | −1.3282E−01 | 2.5742E−01 | −3.8435E−01 | 4.3650E−01 |
| R9 | 7.3490E+01 | −9.9465E−02 | 1.2686E−01 | −2.4438E−01 | 4.6884E−01 | −7.3038E−01 | 8.4891E−01 |
| R10 | 3.5447E+01 | −1.0502E−01 | 9.5764E−02 | −1.1532E−01 | 1.4773E−01 | −1.6844E−01 | 1.5186E−01 |
| R11 | −4.3742E+01 | −1.3648E−02 | −4.6536E−03 | 1.7229E−03 | −1.2438E−03 | 6.0722E−04 | −2.8499E−04 |
| R12 | −8.4711E+01 | −8.0237E−03 | −2.9588E−03 | 4.6565E−03 | −5.1957E−03 | 3.3360E−03 | −1.4360E−03 |
| R13 | 2.1465E+01 | −3.6075E−02 | 3.3199E−03 | 2.8241E−03 | −1.5109E−03 | 3.8292E−04 | −6.0820E−05 |
| R14 | −4.1679E+00 | −2.1407E−02 | 1.5671E−03 | 7.8176E−04 | −2.9937E−04 | 5.4623E−05 | −6.3898E−06 |

TABLE 6

| | Aspherical Coefficient | | | | | | | |
|---|---|---|---|---|---|---|---|---|
| | A16 | A18 | A20 | A22 | A24 | A26 | A28 | A30 |
| R1 | −4.1326E−02 | 2.1479E−02 | −7.9664E−03 | 2.0550E−03 | −3.5010E−04 | 3.5403E−05 | −1.6090E−06 | 0.0000E+00 |
| R2 | 1.3592E−01 | −8.8767E−02 | 3.9740E−02 | −1.1965E−02 | 2.3041E−03 | −2.5453E−04 | 1.2132E−05 | 0.0000E+00 |
| R3 | −4.3754E−01 | 3.7795E−01 | −2.3035E−01 | 9.7842E−02 | −2.8068E−02 | 5.1065E−03 | −5.1825E−04 | 2.1188E−05 |
| R4 | 5.3677E+00 | −5.5871E+00 | 4.2186E+00 | −2.2870E+00 | 8.6717E−01 | −2.1820E−01 | 3.2719E−02 | −2.2118E−03 |
| R5 | 4.8703E+00 | −5.0133E+00 | 3.7571E+00 | −2.0269E+00 | 7.6606E−01 | −1.9232E−01 | 2.8783E−02 | −1.9422E−03 |
| R6 | −2.8463E+00 | 2.6617E+00 | −1.8054E+00 | 8.8172E−01 | −3.0275E−01 | 6.9495E−02 | −9.5942E−03 | 6.0362E−04 |
| R7 | −6.2630E+00 | 5.6310E+00 | −3.7060E+00 | 1.7643E+00 | −5.9129E−01 | 1.3233E−01 | −1.7758E−02 | 1.0814E−03 |
| R8 | −3.7788E−01 | 2.5066E−01 | −1.2742E−01 | 4.9084E−02 | −1.3911E−02 | 2.7355E−03 | −3.3240E−04 | 1.8728E−05 |
| R9 | −7.2543E−01 | 4.5544E−01 | −2.0939E−01 | 6.9675E−02 | −1.6344E−02 | 2.5662E−03 | −2.4236E−04 | 1.0422E−05 |
| R10 | −1.0318E−01 | 5.1852E−02 | −1.9025E−02 | 5.0099E−03 | −9.1966E−04 | 1.1159E−04 | −8.0387E−06 | 2.6023E−07 |
| R11 | 1.5650E−04 | −7.3328E−05 | 2.4349E−05 | −5.5212E−06 | 8.4244E−07 | −8.3178E−08 | 4.8134E−09 | −1.2399E−10 |
| R12 | 4.3980E−04 | −9.7484E−05 | 1.5619E−05 | −1.7833E−06 | 1.4091E−07 | −7.2975E−09 | 2.2220E−10 | −3.0074E−12 |
| R13 | 6.6122E−06 | −5.1166E−07 | 2.8591E−08 | −1.1491E−09 | 3.2464E−11 | −6.1253E−13 | 6.9341E−15 | −3.5626E−17 |
| R14 | 5.1960E−07 | −3.0282E−08 | 1.2745E−09 | −3.8397E−11 | 8.0618E−13 | −1.1179E−14 | 9.1777E−17 | −3.3673E−19 |

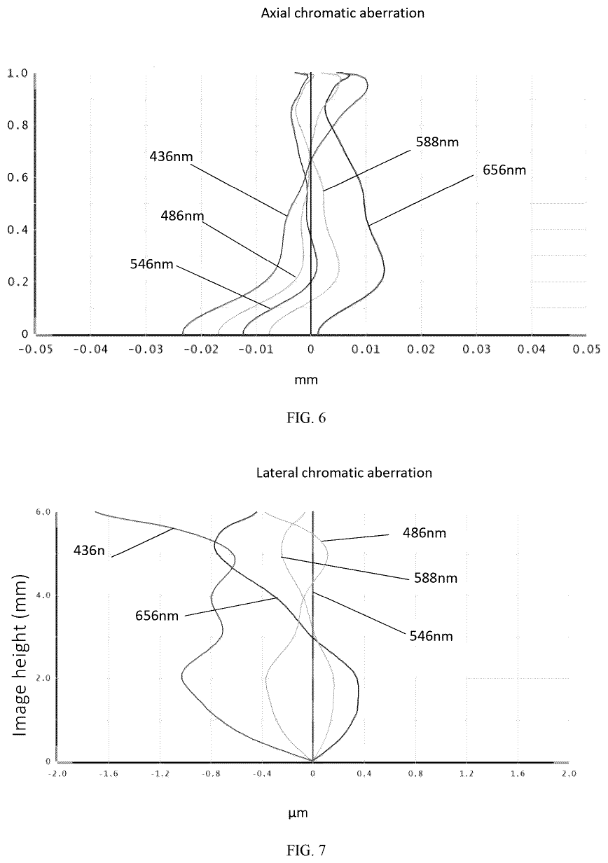

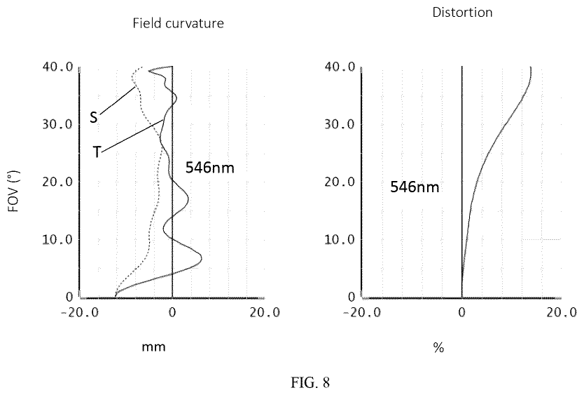

FIG. 6 and FIG. 7 show axial chromatic aberration and lateral chromatic aberration of the light at wavelengths of 656 nm, 588 nm, 546 nm, 486 nm and 436 nm after passing the imaging optical lens 20 according to the second embodiment. FIG. 8 shows field curvature and distortion of light with a wavelength of 546 nm after passing through the imaging optical lens 20 according to the second embodiment. In FIG. 8, S is a field curvature in a sagittal direction, and T is a field curvature in a tangential direction.

In an example, the pupil entering diameter ENPD of the imaging optical lens 20 is 3.447 mm, the image height IH at 1.0 field of view is 6.000 mm, and the field of view FOV in the 1.0 field of view diagonal direction is 80.00°, the image height IHm at MIC field of view is 6.300 mm, and the field of view FOVm in the MIC field of view diagonal direction is 83.42°. The imaging optical lens 20 meets the requirements of large-aperture, wide-angle and ultra-thinness design, the axial and off-axis chromatic aberrations are fully corrected, and it has excellent optical characteristics.

### Third Embodiment

The third embodiment is substantially the same as the first embodiment. The symbols of the third embodiment have the same meaning as in the first embodiment, and only the differences are listed as below.

In an example, the image-side surface of the fourth lens L4 is convex in a paraxial region, and the image-side surface of the sixth lens L6 is convex in a paraxial region.

Table 7 shows the design data of the imaging optical lens 30 according to the third embodiment of the present disclosure.

TABLE 7

| | R | d | | nd | | νd | |
|---|---|---|---|---|---|---|---|
| S1 | ∞ | d0= | −0.889 | | | | |
| R1 | 2.732 | d1= | 1.234 | nd1 | 1.4959 | ν1 | 81.65 |
| R2 | 9.931 | d2= | 0.405 | | | | |
| R3 | 7.272 | d3= | 0.150 | nd2 | 1.6797 | ν2 | 17.05 |
| R4 | 5.448 | d4= | 0.311 | | | | |
| R5 | 8.364 | d5= | 0.334 | nd3 | 1.5444 | ν3 | 55.82 |
| R6 | 19.095 | d6= | 0.526 | | | | |
| R7 | −21.120 | d7= | 0.204 | nd4 | 1.6700 | ν4 | 19.39 |
| R8 | −276.601 | d8= | 0.197 | | | | |
| R9 | 16.272 | d9= | 0.239 | nd5 | 1.6153 | ν5 | 25.94 |
| R10 | 17.542 | d10= | 0.665 | | | | |
| R11 | 17.136 | d11= | 1.542 | nd6 | 1.5661 | ν6 | 37.71 |
| R12 | −42.930 | d12= | 0.363 | | | | |
| R13 | 44.858 | d13= | 1.626 | nd7 | 1.5444 | ν7 | 55.82 |
| R14 | 3.474 | d14= | 0.500 | | | | |
| R15 | ∞ | d15= | 0.110 | ndg | 1.5168 | νg | 64.20 |
| R16 | ∞ | d16= | 0.427 | | | | |

Table 8 and Table 9 show the aspherical surface data of the lenses in the imaging optical lens 30 according to the third embodiment of the present disclosure.

TABLE 8

| | Conical Coefficient | Aspherical Coefficient | | | | | |
|---|---|---|---|---|---|---|---|
| | k | A4 | A6 | A8 | A10 | A12 | A14 |
| R1 | −6.3622E−01 | 2.0165E−03 | 6.4173E−03 | −1.6689E−02 | 2.7892E−02 | −3.0680E−02 | 2.3091E−02 |
| R2 | −3.2511E+00 | −8.1260E−05 | −3.1082E−03 | 1.1348E−02 | −2.5058E−02 | 3.5643E−02 | −3.4332E−02 |
| R3 | 6.1676E+00 | −1.2902E−02 | 8.5210E−03 | −1.1936E−02 | 2.4951E−02 | −3.4915E−02 | 3.3576E−02 |
| R4 | 1.5636E+00 | −1.0406E−02 | −1.1590E−02 | 9.3714E−02 | −3.1690E−01 | 7.0287E−01 | −1.0693E+00 |
| R5 | 1.2794E+01 | −1.0467E−02 | 1.6417E−02 | −9.3161E−02 | 2.9113E−01 | −5.9953E−01 | 8.5405E−01 |
| R6 | −1.1994E+01 | −2.4661E−03 | −2.9705E−02 | 1.4343E−01 | −4.5223E−01 | 9.4287E−01 | −1.3600E+00 |
| R7 | 5.9278E+01 | −4.2615E−02 | 4.6104E−02 | −1.5748E−01 | 3.6050E−01 | −6.0734E−01 | 7.4114E−01 |
| R8 | −9.9900E+01 | −5.6480E−02 | 6.4061E−02 | −1.1376E−01 | 1.3789E−01 | −1.3017E−01 | 1.0014E−01 |
| R9 | 6.3182E+01 | −7.9183E−02 | 8.6030E−02 | −6.4844E−02 | −7.3564E−03 | 9.0957E−02 | −1.3007E−01 |
| R10 | −1.1359E+01 | −6.7938E−02 | 6.1443E−02 | 4.8457E−02 | 2.5283E−02 | −3.3320E−03 | −7.1181E−03 |
| R11 | −3.3305E+01 | −1.8980E−02 | 8.9976E−03 | −1.1653E−02 | 1.1635E−02 | −8.7588E−03 | 4.7235E−03 |
| R12 | 7.8035E+01 | −1.8932E−02 | 1.0897E−02 | −4.3728E−03 | 1.2589E−03 | −3.3907E−04 | 8.6749E−05 |
| R13 | 5.9794E+01 | −4.2505E−02 | 1.4962E−02 | −3.4229E−03 | 4.4990E−04 | −2.2381E−05 | −2.5980E−06 |
| R14 | −5.9288E+00 | −1.9364E−02 | 5.2110E−03 | −1.0842E−03 | 1.7148E−04 | −2.0827E−05 | 1.9467E−06 |

TABLE 9

| | Aspherical Coefficient | | | | | | | |
|---|---|---|---|---|---|---|---|---|
| | A16 | A18 | A20 | A22 | A24 | A26 | A28 | A30 |
| R1 | −1.2165E−02 | 4.5245E−03 | −1.1822E−03 | 2.1227E−04 | −2.4931E−05 | 1.7245E−06 | −5.3254E−08 | 0.0000E+00 |
| R2 | 2.2968E−02 | −1.0784E−02 | 3.5400E−03 | −7.9518E−04 | 1.1643E−04 | −1.0009E−05 | 3.8309E−07 | 0.0000E+00 |
| R3 | −2.1994E−02 | 9.3189E−03 | −2.0951E−03 | −6.8107E−05 | 2.0080E−04 | −6.0559E−05 | 8.3651E−06 | −4.6490E−07 |
| R4 | 1.1484E+00 | −8.8396E−01 | 4.8920E−01 | −1.9291E−01 | 5.2854E−02 | −9.5565E−03 | 1.0248E−03 | −4.9345E−05 |
| R5 | −8.6385E−01 | 6.2903E−01 | −3.3057E−01 | 1.2420E−01 | −3.2517E−02 | 5.6338E−03 | −5.8037E−04 | 2.6907E−05 |
| R6 | 1.3958E+00 | −1.0340E+00 | 5.5424E−01 | −2.1291E−01 | 5.7126E−02 | −1.0163E−02 | 1.0771E−03 | −5.1466E−05 |
| R7 | −6.4813E−01 | 4.0330E−01 | −1.7625E−01 | 5.2599E−02 | −1.0120E−02 | 1.1042E−03 | −4.5105E−05 | −1.1733E−06 |
| R8 | −6.3044E−02 | 3.1867E−02 | −1.2567E−02 | 3.7445E−03 | −8.1104E−04 | 1.2047E−04 | −1.0990E−05 | 4.6518E−07 |
| R9 | 1.0965E−01 | −6.2973E−02 | 2.5613E−02 | −7.4067E−03 | 1.4928E−03 | −1.9961E−04 | 1.5931E−05 | −5.7483E−07 |
| R10 | 7.0291E−03 | −3.5986E−03 | 1.1997E−03 | −2.7301E−04 | 4.2210E−05 | −4.2472E−06 | 2.5084E−07 | −6.5939E−09 |
| R11 | −1.8115E−03 | 4.9481E−04 | −9.6032E−05 | 1.3077E−05 | −1.2152E−06 | 7.3058E−08 | −2.5511E−09 | 3.9148E−11 |
| R12 | −1.8420E−05 | 2.9604E−06 | −3.4680E−07 | 2.8988E−08 | −1.6809E−09 | 6.4218E−11 | −1.4541E−12 | 1.4791E−14 |
| R13 | 6.1022E−07 | −6.0005E−08 | 3.6829E−09 | −1.5206E−10 | 4.2456E−12 | −7.7161E−14 | 8.2568E−16 | −3.9510E−18 |
| R14 | −1.3932E−07 | 7.5705E−09 | −3.0848E−10 | 9.2455E−12 | −1.9737E−13 | 2.8365E−15 | −2.4571E−17 | 9.6865E−20 |

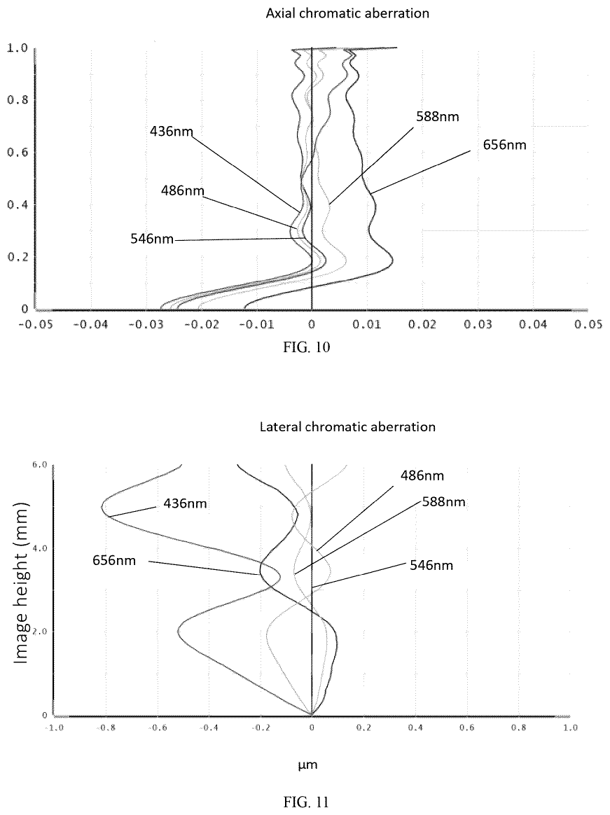

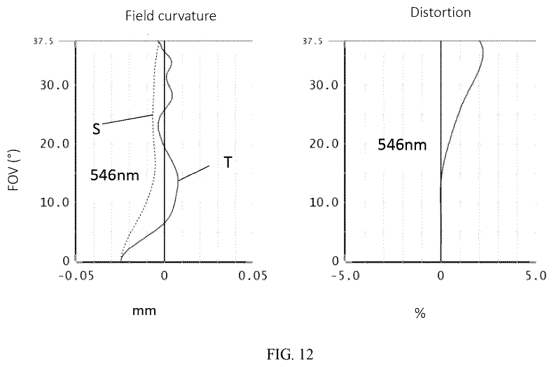

FIG. 10 and FIG. 11 show axial chromatic aberration and lateral chromatic aberration of the light at wavelengths of 656 nm, 588 nm, 546 nm, 486 nm and 436 nm after passing through the imaging optical lens 30 according to the third embodiment. FIG. 12 shows field curvature and distortion of light at a wavelength of 546 nm after passing through the imaging optical lens 30 according to the third embodiment. In FIG. 12, S is a field curvature in a sagittal direction, and T is a field curvature in a meridional direction.

In an example, the pupil entering diameter ENPD of the imaging optical lens 30 is 4.194 mm, the image height IH at 1.0 field of view is 6.000 mm, and the field of view FOV in the 1.0 field of view diagonal direction is 74.98°, the image height IHm at MIC field of view is 6.300 mm, and the field of view FOVm in the MIC field of view diagonal direction is 77.92°. The imaging optical lens 30 meets the requirements of large-aperture, wide-angle and ultra-thinness design, the axial and off-axis chromatic aberrations are fully corrected, and it has excellent optical characteristics.

### Fourth Embodiment

The fourth embodiment is substantially the same as the first embodiment. The symbols in the fourth embodiment have the same meaning as in the first embodiment, and only the differences are listed as below.

Table 10 shows the design data of the imaging optical lens 40 according to the fourth embodiment of the present disclosure.

TABLE 10

| | R | d | | nd | | νd | |
|---|---|---|---|---|---|---|---|
| S1 | ∞ | d0= | −0.852 | | | | |
| R1 | 2.205 | d1= | 0.917 | nd1 | 1.4959 | ν1 | 81.65 |
| R2 | 5.650 | d2= | 0.236 | | | | |
| R3 | 4.865 | d3= | 0.173 | nd2 | 1.6700 | ν2 | 19.39 |
| R4 | 3.802 | d4= | 0.204 | | | | |
| R5 | 6.838 | d5= | 0.381 | nd3 | 1.5444 | ν3 | 55.82 |
| R6 | 19.246 | d6= | 0.416 | | | | |
| R7 | −39.272 | d7= | 0.265 | nd4 | 1.6700 | ν4 | 19.39 |
| R8 | 35.558 | d8= | 0.263 | | | | |
| R9 | 15.944 | d9= | 0.328 | nd5 | 1.6153 | ν5 | 25.94 |
| R10 | 17.924 | d10= | 0.576 | | | | |
| R11 | 5.983 | d11= | 0.607 | nd6 | 1.5661 | ν6 | 37.71 |
| R12 | 110.439 | d12= | 0.796 | | | | |
| R13 | 45.265 | d13= | 0.823 | nd7 | 1.5444 | ν7 | 55.82 |
| R14 | 2.555 | d14= | 0.500 | | | | |
| R15 | ∞ | d15= | 0.110 | ndg | 1.5168 | νg | 64.20 |
| R16 | ∞ | d16= | 0.512 | | | | |

Table 11 and Table 12 show the aspherical surface data of the lenses in the imaging optical lens 40 according to the fourth embodiment of the present disclosure.

TABLE 11

| | Conical Coefficient | Aspherical Coefficient | | | | | |
|---|---|---|---|---|---|---|---|
| | k | A4 | A6 | A8 | A10 | A12 | A14 |
| R1 | −4.8939E−01 | 2.0757E−03 | 1.9108E−02 | −5.9971E−02 | 1.2511E−01 | −1.7438E−01 | 1.6858E−01 |
| R2 | 5.7554E−01 | −3.2860E−03 | 1.2013E−02 | −3.3429E−02 | 6.5363E−02 | −8.7344E−02 | 8.1258E−02 |
| R3 | 3.8927E+00 | −2.3140E−02 | 1.9521E−02 | −7.4518E−02 | 2.9461E−01 | −7.3048E−01 | 1.2033E+00 |
| R4 | 1.6143E+00 | −1.8645E−02 | −2.2731E−02 | 2.0945E−01 | −8.4654E−01 | 2.2960E+00 | −4.3662E+00 |
| R5 | 1.7000E+01 | −1.8283E−02 | 5.4673E−02 | −3.2196E−01 | 1.1977E+00 | −3.0200E+00 | 5.3145E+00 |
| R6 | 9.3297E+01 | −1.1110E−02 | 1.7769E−02 | −1.1573E−01 | 4.4208E−01 | −1.1717E+00 | 2.2430E+00 |
| R7 | 5.9278E+01 | −5.9598E−02 | 1.1032E−01 | −5.1419E−01 | 1.5381E+00 | −3.1457E+00 | 4.3455E+00 |
| R8 | −9.1994E+01 | −6.0658E−02 | 2.5695E−02 | 1.5402E−01 | −9.7720E−01 | 2.7955E+00 | −5.0443E+00 |
| R9 | 4.2202E+01 | −1.0325E−01 | 1.7147E−01 | −4.4235E−01 | 1.0010E+00 | −1.6789E+00 | 2.0259E+00 |
| R10 | 5.5486E+01 | −1.0324E−01 | 1.1282E−01 | −1.7842E−01 | 2.5007E−01 | −2.6302E−01 | 2.0216E−01 |
| R11 | −3.1440E+01 | −2.3853E−02 | 5.9475E−03 | −1.7247E−03 | −5.3882E−03 | 6.3923E−03 | −3.7711E−03 |
| R12 | 9.5763E+01 | −3.1608E−02 | 2.5723E−02 | −2.2038E−02 | 1.3803E−02 | −7.0603E−03 | 2.9173E−03 |
| R13 | 8.0932E+01 | −1.1917E−01 | 5.1033E−02 | −1.7506E−02 | 4.6846E−03 | −8.8152E−04 | 1.1319E−04 |
| R14 | −9.9719E+00 | −5.4467E−02 | 2.2841E−02 | −7.9143E−03 | 2.1012E−03 | −4.1784E−04 | 6.1886E−05 |

TABLE 12

| | Aspherical Coefficient | | | | | | | |
|---|---|---|---|---|---|---|---|---|
| | A16 | A18 | A20 | A22 | A24 | A26 | A28 | A30 |
| R1 | −1.1531E−01 | 5.6177E−02 | −1.9365E−02 | 4.6133E−03 | −7.2210E−04 | 6.6781E−05 | −2.7632E−06 | 0.0000E+00 |
| R2 | −5.3405E−02 | 2.4909E−02 | −8.1873E−03 | 1.8574E−03 | −2.7883E−04 | 2.5320E−05 | −1.0794E−06 | 0.0000E+00 |
| R3 | −1.3740E+00 | 1.1132E+00 | −6.4473E−01 | 2.6513E−01 | −7.5548E−02 | 1.4167E−02 | −1.5700E−03 | 7.7729E−05 |
| R4 | 5.9571E+00 | −5.8942E+00 | 4.2323E+00 | −2.1819E+00 | 7.8679E−01 | −1.8835E−01 | 2.6894E−02 | −1.7337E−03 |
| R5 | −6.6512E+00 | 5.9765E+00 | −3.8529E+00 | 1.7596E+00 | −5.5296E−01 | 1.1297E−01 | −1.3384E−02 | 6.8752E−04 |
| R6 | −3.1526E+00 | 3.2681E+00 | −2.4862E+00 | 1.3672E+00 | −5.2773E−01 | 1.3541E−01 | −2.0720E−02 | 1.4297E−03 |
| R7 | −3.9173E+00 | 2.0191E+00 | −1.7877E−01 | −5.4162E−01 | 4.1846E−01 | −1.5264E−01 | 2.9161E−02 | −2.3457E−03 |
| R8 | 6.2309E+00 | −5.4406E+00 | 3.3929E+00 | −1.5026E+00 | 4.6155E−01 | −9.3486E−02 | 1.1226E−02 | −6.0516E−04 |
| R9 | −1.7674E+00 | 1.1198E+00 | −5.1401E−01 | 1.6878E−01 | −3.8556E−02 | 5.8059E−03 | −5.1680E−04 | 2.0546E−05 |
| R10 | −1.1377E−01 | 4.6921E−02 | −1.4091E−02 | 3.0319E−03 | −4.5344E−04 | 4.4627E−05 | −2.5929E−06 | 6.7279E−08 |
| R11 | 1.4227E−03 | −3.7345E−04 | 7.0791E−05 | −9.7170E−06 | 9.3982E−07 | −6.0397E−08 | 2.3021E−09 | −3.9225E−11 |
| R12 | −9.3213E−04 | 2.2215E−04 | −3.8499E−05 | 4.7433E−06 | −4.0301E−07 | 2.2395E−08 | −7.3170E−10 | 1.0649E−11 |
| R13 | −9.7244E−06 | 5.2160E−07 | −1.2478E−08 | −3.9511E−10 | 4.5283E−11 | −1.7190E−12 | 3.2535E−14 | −2.5640E−16 |
| R14 | −6.8191E−06 | 5.5748E−07 | −3.3552E−08 | 1.4628E−09 | −4.4838E−11 | 9.1483E−13 | −1.1142E−14 | 6.1242E−17 |

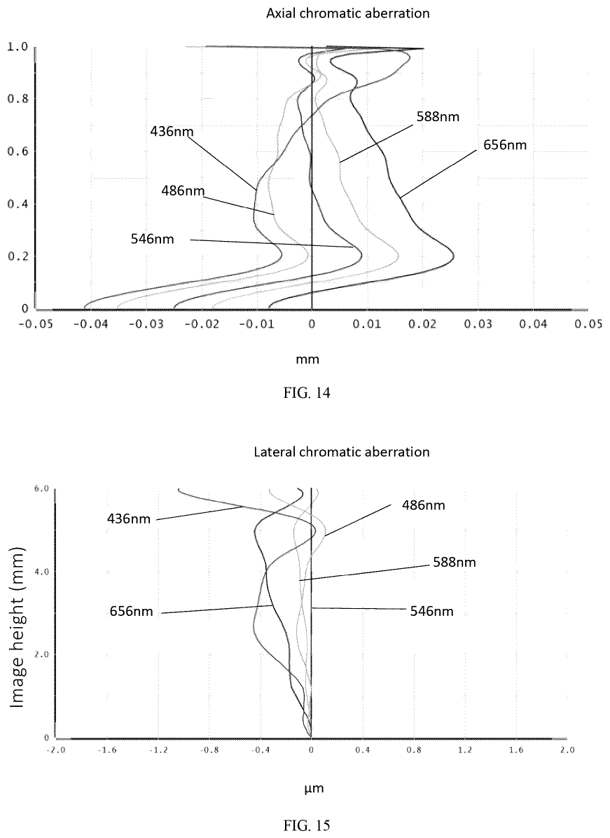

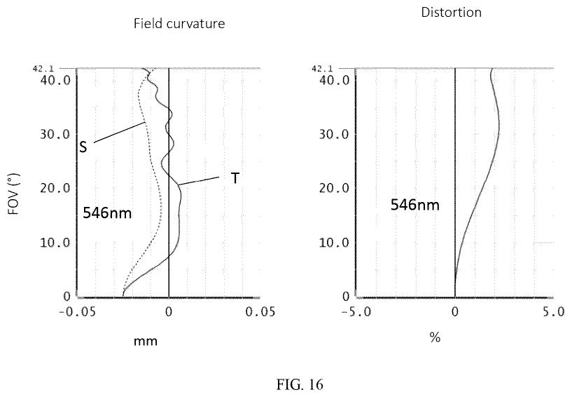

FIG. 14 and FIG. 15 show axial chromatic aberration and lateral chromatic aberration of the light at wavelengths of 656 nm, 588 nm, 546 nm, 486 nm and 436 nm after passing through the imaging optical lens 40 according to the fourth embodiment. FIG. 16 shows field curvature and distortion of light at a wavelength of 546 nm after passing through the imaging optical lens 40 according to the embodiment. In FIG. 16, S is a field curvature in a sagittal direction, and T is a field curvature in a meridional direction.

In an example, the pupil entering diameter ENPD of the imaging optical lens 40 is 3.558 mm, the image height IH at 1.0 field of view is 6.000 mm, and the field of view FOV in the 1.0 field of view diagonal direction is 84.25°, the image height IHm at MIC field of view is 6.300 mm, and the field of view FOVm in the MIC field of view diagonal direction is 86.82°. The imaging optical lens 40 meets the requirements of large-aperture, wide-angle and ultra-thinness design, the axial and off-axis chromatic aberrations are fully corrected, and it has excellent optical characteristics.

### Fifth Embodiment

The fifth embodiment is substantially the same as the first embodiment. The symbols of the fifth embodiment have the same meaning as the first embodiment, and only the differences are listed as below.

In an example, the image-side surface of the sixth lens L6 is convex in a paraxial region.

Table 13 shows the design data of the imaging optical lens 50 according to the fifth embodiment of the present disclosure.

TABLE 13

| | R | d | | nd | | νd | |
|---|---|---|---|---|---|---|---|
| S1 | ∞ | d0= | −0.883 | | | | |
| R1 | 2.342 | d1= | 1.041 | nd1 | 1.4959 | ν1 | 81.65 |
| R2 | 7.664 | d2= | 0.221 | | | | |
| R3 | 5.245 | d3= | 0.150 | nd2 | 1.6700 | ν2 | 19.39 |
| R4 | 4.054 | d4= | 0.263 | | | | |
| R5 | 7.246 | d5= | 0.339 | nd3 | 1.5444 | ν3 | 55.82 |
| R6 | 13.833 | d6= | 0.451 | | | | |
| R7 | −23.194 | d7= | 0.268 | nd4 | 1.6700 | ν4 | 19.39 |
| R8 | 52.440 | d8= | 0.211 | | | | |
| R9 | 13.771 | d9= | 0.476 | nd5 | 1.6153 | ν5 | 25.94 |
| R10 | 18.076 | d10= | 0.604 | | | | |
| R11 | 7.706 | d11= | 0.817 | nd6 | 1.5661 | ν6 | 37.71 |
| R12 | −77.070 | d12= | 0.556 | | | | |
| R13 | 42.788 | d13= | 0.992 | nd7 | 1.5444 | ν7 | 55.82 |
| R14 | 2.800 | d14= | 0.500 | | | | |
| R15 | ∞ | d15= | 0.110 | ndg | 1.5168 | νg | 64.20 |
| R16 | ∞ | d16= | 0.575 | | | | |

Table 14 and Table 15 show the aspherical surface data of the lenses in the imaging optical lens 50 according to the fifth embodiment of the present disclosure.

TABLE 14

| | Conical Coefficient | Aspherical Coefficient | | | | | |
|---|---|---|---|---|---|---|---|
| | k | A4 | A6 | A8 | A10 | A12 | A14 |
| R1 | −5.1012E−01 | 2.0552E−03 | 1.3039E−02 | −3.8276E−02 | 7.6077E−02 | −1.0164E−01 | 9.4139E−02 |
| R2 | 9.9264E−02 | −2.5305E−03 | 1.0855E−03 | 4.1603E−03 | −1.2489E−02 | 1.9334E−02 | −1.9152E−02 |
| R3 | 4.5049E+00 | −2.4261E−02 | 2.8547E−02 | −9.3219E−02 | 3.1560E−01 | −7.1723E−01 | 1.1198E+00 |
| R4 | 1.8410E+00 | −1.9589E−02 | −1.0369E−02 | 1.5857E−01 | −6.6259E−01 | 1.7852E+00 | −3.3045E+00 |
| R5 | 1.6863E+01 | −1.4013E−02 | 2.0754E−02 | −1.2746E−01 | 4.6787E−01 | −1.1322E+00 | 1.8762E+00 |
| R6 | 8.2283E+01 | −8.8807E−03 | −2.8261E−02 | 1.9269E−01 | −8.1239E−01 | 2.2164E+00 | −4.1603E+00 |
| R7 | 5.9278E+01 | −5.1366E−02 | 6.6507E−02 | −2.1766E−01 | 4.2343E−01 | −4.0686E−01 | −2.2404E−01 |
| R8 | 9.9900E+01 | −6.2428E−02 | 2.9060E−02 | 9.5128E−02 | −5.8600E−01 | 1.5294E+00 | −2.5200E+00 |
| R9 | 2.3507E+01 | −6.2764E−02 | 4.0343E−02 | 2.4849E−02 | −1.8043E−01 | 3.8207E−01 | −5.0304E−01 |
| R10 | 4.5629E+01 | −5.4452E−02 | 3.4798E−02 | −2.4826E−02 | 1.5520E−02 | −5.4523E−03 | −8.4921E−04 |
| R11 | −3.6339E+01 | −1.6538E−02 | 1.0642E−02 | −1.7225E−02 | 1.6228E−02 | −1.0965E−02 | 5.3033E−03 |
| R12 | 9.9900E+01 | −2.0221E−02 | 2.0535E−02 | −1.6580E−02 | 9.0397E−03 | −3.7614E−03 | 1.1965E−03 |
| R13 | 5.8985E+01 | −8.6371E−02 | 3.7314E−02 | −1.2998E−02 | 3.3789E−03 | −6.1940E−04 | 8.0973E−05 |
| R14 | −1.1615E+01 | −2.7530E−02 | 6.7844E−03 | −9.7530E−04 | −5.7238E−05 | 6.0882E−05 | −1.4512E−05 |

TABLE 15

| | Aspherical Coefficient | | | | | | | |
|---|---|---|---|---|---|---|---|---|
| | A16 | A18 | A20 | A22 | A24 | A26 | A28 | A30 |
| R1 | −6.1495E−02 | 2.8499E−02 | −9.3083E−03 | 2.0939E−03 | −3.0863E−04 | 2.6828E−05 | −1.0424E−06 | 0.0000E+00 |
| R2 | 1.2792E−02 | −5.8379E−03 | 1.8004E−03 | −3.6042E−04 | 4.2669E−05 | −2.3531E−06 | 1.5550E−08 | 0.0000E+00 |
| R3 | −1.2363E+00 | 9.8104E−01 | −5.6151E−01 | 2.2968E−01 | −6.5447E−02 | 1.2332E−02 | −1.3803E−03 | 6.9441E−05 |
| R4 | 4.3321E+00 | −4.0838E+00 | 2.7777E+00 | −1.3510E+00 | 4.5811E−01 | −1.0285E−01 | 1.3738E−02 | −8.2642E−04 |
| R5 | −2.1767E+00 | 1.7860E+00 | −1.0333E+00 | 4.1384E−01 | −1.1013E−01 | 1.7935E−02 | −1.4890E−03 | 3.5194E−05 |
| R6 | 5.5617E+00 | −5.3892E+00 | 3.8018E+00 | −1.9356E+00 | 6.9340E−01 | −1.6593E−01 | 2.3823E−02 | −1.5524E−03 |
| R7 | 1.3419E+00 | −2.1388E+00 | 2.0071E+00 | −1.2338E+00 | 5.0389E−01 | −1.3217E−01 | 2.0198E−02 | −1.3687E−03 |
| R8 | 2.8525E+00 | −2.2888E+00 | 1.3143E+00 | −5.3684E−01 | 1.5230E−01 | −2.8523E−02 | 3.1700E−03 | −1.5829E−04 |
| R9 | 4.5559E−01 | −2.9375E−01 | 1.3627E−01 | −4.5206E−02 | 1.0465E−02 | −1.6051E−03 | 1.4647E−04 | −6.0122E−06 |
| R10 | 2.0740E−03 | −1.1692E−03 | 3.8201E−04 | −8.1361E−05 | 1.1503E−05 | −1.0451E−06 | 5.5356E−08 | −1.3005E−09 |
| R11 | −1.8310E−03 | 4.5054E−04 | −7.8785E−05 | 9.7014E−06 | −8.2213E−07 | 4.5653E−08 | −1.4958E−09 | 2.1924E−11 |
| R12 | −2.8489E−04 | 4.9866E−05 | −6.3209E−06 | 5.7010E−07 | −3.5559E−08 | 1.4557E−09 | −3.5157E−11 | 3.7949E−13 |
| R13 | −7.7073E−06 | 5.4102E−07 | −2.8052E−08 | 1.0625E−09 | −2.8594E−11 | 5.1805E−13 | −5.6631E−15 | 2.8206E−17 |
| R14 | 2.0417E−06 | −1.9283E−07 | 1.2693E−08 | −5.8496E−10 | 1.8524E−11 | −3.8415E−13 | 4.6982E−15 | −2.5686E−17 |

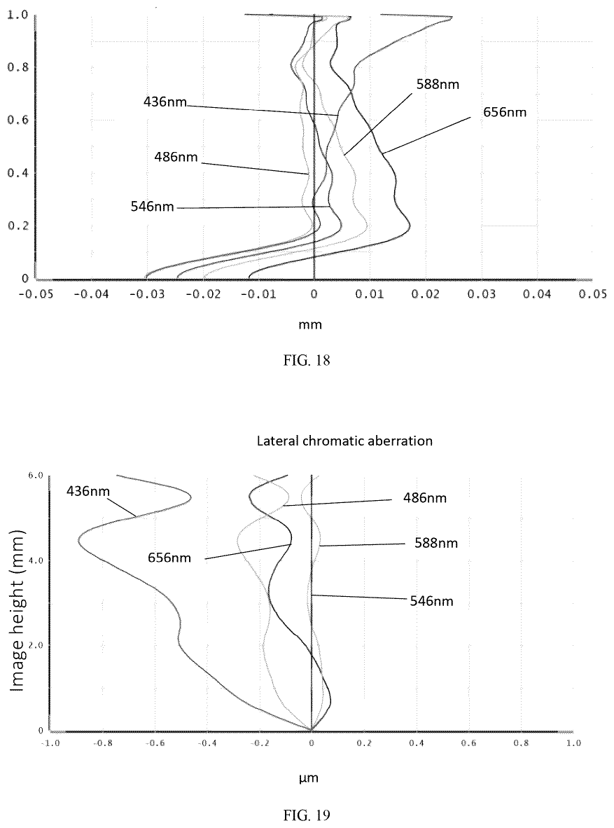

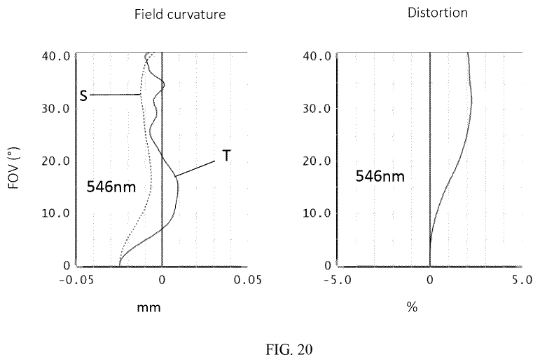

FIG. 18 and FIG. 19 show axial chromatic aberration and lateral chromatic aberration of the light at wavelengths of 656 nm, 588 nm, 546 nm, 486 nm and 436 nm after passing through the imaging optical lens 50 according to the fifth embodiment. FIG. 20 shows field curvature and distortion of light at a wavelength of 546 nm after passing through the imaging optical lens 50 according to the fifth embodiment. In FIG. 20, S is a field curvature in a sagittal direction, and T is a field curvature in a meridional direction.

In an example, the pupil entering diameter ENPD of the imaging optical lens 50 is 3.738 mm, the image height IH at 1.0 field of view is 6.000 mm, and the field of view FOV in the 1.0 field of view diagonal direction is 81.41°, the image height IHm at MIC field of view is 6.300 mm, and the field of view FOVm in the MIC field of view diagonal direction is 84.27°. The imaging optical lens 50 meets the requirements of large-aperture, wide-angle and ultra-thinness design, the axial and off-axis chromatic aberrations are fully corrected, and it has excellent optical characteristics.

Table 16 shows the values of parameters in the first embodiment, the second embodiment, the third embodiment, the fourth embodiment and the fifth embodiment corresponding to parameters specified in some conditions.

TABLE 16

| Parameters and | Embodiment | Embodiment | Embodiment | Embodiment | Embodiment |
|---|---|---|---|---|---|
| Conditions | 1 | 2 | 3 | 4 | 5 |
| (R3 + R4)/f | 1.29 | 1.11 | 1.70 | 1.36 | 1.39 |
| f6/R12-f7/R14 | 2.34 | 2.98 | 1.50 | 2.05 | 1.81 |
| (R5 + R6)/(R5 − R6) | −2.73 | −2.84 | −2.56 | −2.10 | −3.20 |
| d1/d2 | 5.85 | 11.95 | 3.05 | 3.89 | 4.71 |
| f | 6.322 | 6.187 | 7.505 | 6.381 | 6.701 |
| f1 | 6.448 | 6.496 | 7.168 | 6.680 | 6.366 |
| f2 | −23.947 | −24.836 | −32.628 | −27.473 | −27.733 |
| f3 | 21.548 | 22.776 | 26.924 | 19.190 | 27.334 |
| f4 | −31.548 | −42.056 | −33.731 | −27.480 | −23.681 |
| f5 | 164.805 | −910.387 | 337.696 | 218.625 | 89.360 |
| f6 | 10.811 | 15.616 | 21.701 | 11.082 | 12.342 |
| f7 | −5.085 | −6.656 | −6.984 | −4.987 | −5.528 |
| FNO | 1.794 | 1.795 | 1.789 | 1.793 | 1.793 |
| TTL | 6.860 | 7.243 | 8.833 | 7.107 | 7.574 |
| IH | 6.000 | 6.000 | 6.000 | 6.000 | 6.000 |
| FOV | 85.11° | 80.00° | 74.98° | 84.25° | 81.41° |

Those skilled in the art should understand that the above embodiments are just specific embodiments for implementing the present disclosure, and in practical applications, various changes may be implemented in form and detail without departing from the spirit and scope of the present disclosure.

What is claimed is:

1. An imaging optical lens, comprising seven lenses, which are, from an object side to an image side, a first lens having a positive refractive power, a second lens having a negative refractive power, a third lens having a positive refractive power, a fourth lens having a negative refractive power, a fifth lens, a sixth lens having a positive refractive power and a seventh lens having a negative refractive power,
wherein an object-side surface of the first lens is convex in a paraxial region, an image-side surface of the first lens is concave in a paraxial region, an object-side surface of the second lens is convex in a paraxial region, an image-side surface of the second lens is concave in a paraxial region, an object-side surface of the third lens is convex in a paraxial region, an image-side surface of the third lens is concave in a paraxial region, an object-side surface of the fourth lens is concave in a paraxial region, an object-side surface of the fifth lens is convex in a paraxial region, an image-side surface of the fifth lens is concave in a paraxial region, an object-side surface of the sixth lens is convex in a paraxial region, an object-side surface of the seventh lens is convex in a paraxial region, and an image-side surface of the seventh lens is concave in a paraxial region; and
a focal length of the imaging optical lens is f, a focal length of the sixth lens is f6, a focal length of the seventh lens is f7, a central curvature radius of the object-side surface of the second lens is R3, a central curvature radius of the image-side surface of the second lens is R4, a central curvature radius of the object-side surface of the third lens is R5, a central curvature radius of the image-side surface of the third lens is R6, a central curvature radius of an image-side surface of the sixth lens is R12, a central curvature radius of the image-side surface of the seventh lens is R14, an axial thickness of the first lens is d1, and an axial distance from the image-side surface of the first lens to the object-side surface of the second lens is d2, where
$$1.1 \leq ( R 3 + R 4 ) / f \leq 1.7 ;$$
$$1. 50 \leq f 6 / R 12 - f 7 / R 14 \leq 3. ;$$
$$and$$
$$- 3.3 \leq ( R 5 + R 6 ) / ( R 5 - R 6 ) \leq - 2 \text{.00} ;$$
$$3. \leq d 1 / d 2 \leq 12.00 .$$

2. The imaging optical lens as described in claim 1, wherein a total optical length of the imaging optical lens is TTL, a field of view of the imaging optical lens in a 1.0 field of view diagonal direction is FOV, and an image height at 1.0 field of view of the imaging optical lens is IH, where
$$0.01 \leq TTL / IH / FOV \leq 0.02 .$$

3. The imaging optical lens as described in claim 1, wherein a focal length of the first lens is f1, where
$$0.95 \leq f 1 / f \leq 1.06 .$$

4. The imaging optical lens as described in claim 1, wherein a central curvature radius of the object-side surface of the first lens is R1, a central curvature radius of an image-side surface of the first lens is R2, and a total optical length of the imaging optical lens is TTL, where
$$- 2.29 \leq ( R 1 + R 2 ) / ( R 1 - R 2 ) \leq - 1 \text{.75} ;$$
$$and$$
$$0.123 \leq d 1 / TTL \leq 0.144 .$$

5. The imaging optical lens as described in claim 1, wherein a focal length of the second lens is f2, an axial thickness of the second lens is d3, and a total optical length of the imaging optical lens is TTL, where
$$- 4.41 \leq f 2 / f \leq - 3.78 ;$$
$$6.97 \leq ( R 3 + R 4 ) / ( R 3 - R 4 ) \leq 9 \text{.18} ;$$
$$and$$
$$0.017 \leq d 3 / TTL \leq 0.033 .$$

6. The imaging optical lens as described in claim 1, wherein a focal length of the third lens is f3, an axial thickness of the third lens is d5, and a total optical length of the imaging optical lens is TTL, where
$$3. \leq f 3 / f \leq 4.1 ;$$
$$and$$
$$0.037 \leq d 5 / TTL \leq 0.059 .$$

7. The imaging optical lens as described in claim 1, wherein a focal length of the fourth lens is f4, a central curvature radius of the object-side surface of the fourth lens is R7, a central curvature radius of the image-side surface of the fourth lens is R8, an axial thickness of the fourth lens is d7, and a total optical length of the imaging optical lens is TTL, where
$$- 6.90 \leq f 4 / f \leq - 3 \text{.53} ;$$
$$- 1.1 \; 7 \leq ( R 7 + R 8 ) / ( R 7 - R 8 ) \leq 0 \text{.94} ;$$
$$and$$
$$0. 023 \leq d 7 / TTL \leq 0.042 .$$

8. The imaging optical lens as described in claim 1, wherein a focal length of the fifth lens is f5, a central curvature radius of the object-side surface of the fifth lens is R9, a central curvature radius of the image-side surface of the fifth lens is R10, an axial thickness of the fifth lens is d9, and a total optical length of the imaging optical lens is TTL, where
$$- 148.4 \leq f 5 / f \leq 45.43 ;$$
$$- 26. 63 \leq ( R 9 + R 10 ) / ( R 9 - R 10 ) \leq 47 \text{.79} ;$$
$$and$$
$$0.027 \leq d 9 / TTL \leq 0.063 .$$

9. The imaging optical lens as described in claim 1, wherein a focal length of the sixth lens is f6, a central curvature radius of the object-side surface of the sixth lens is R11, an axial thickness of the fifth lens is d11, and a total optical length of the imaging optical lens is TTL, where
$$1.71 \leq f 6 / f \leq 2.92 ;$$
$$- 2. 3 \leq ( R 11 + R 12 ) / ( R 11 - R 12 ) \leq - 0 \text{.42} ;$$
$$0.084 \leq d 11 / TTL \leq 0.175 .$$

10. The imaging optical lens as described in claim 1, wherein a focal length of the seventh lens is f7, a central curvature radius of the object-side surface of the seventh lens is R13, an axial thickness of the seventh lens is d13, and a total optical length of the imaging optical lens is TTL, where
$$- 1.08 \leq f 7 / f \leq - 0.78 ;$$
$$1.11 \leq ( R 13 + R 14 ) / ( R 13 - R 14 ) \leq 1.27 ;$$
$$and$$
$$0.082 \leq d 13 / TTL \leq 0.185 .$$

11. The imaging optical lens as described in claim 1, wherein the first lens is made of glass.
